(19) United States
(12) Patent Application Publication
(10) Pub. No.: US 2004/0027425 A1
(43) Pub. Date: Feb. 12, 2004

(54) Refilling Apparatus of Cartridge and Absorber for the Same and Refilling Can for the Same

(76) Inventors: Kuk-Jae Lee, Kyunggi-Do (KR); Ill-jae Lee, Kyunggi-Do (KR)

Correspondence Address: Frank Chau, F. Chau & Associates, 1900 Hempstead Turnpike, Suite 501, East Meadow, NY, 11554, US

(21) Appl. No.: 10/399,373

(22) PCT Filed: Oct. 16, 2001
(86) PCT No.: PCT/KR01/01739

(30) Foreign Application Priority Data
Oct. 16, 2000 (KR) 2000/60810

(51) Int. Cl. B41J 2/17; B41J 2/175

(52) U.S. Cl. 347/84

(57) ABSTRACT

A refilling apparatus for the ink cartridge capable of refilling and/or replenishing the ink cartridge with ink comprises a refilling holder being coupled with a refilling ink can to fill or replenish the ink cartridge with ink, and ink adsorbing means for adsorbing air and/or ink to generate an equalized pressure by adjusting the air pressure inside the ink cartridge so that any ink doesn't leak out from the inside of the ink cartridge.

### TECHNICAL FIELD

The present invention relates to a cartridge of an ink jet printer, and more articularly, to a refilling apparatus of cartridge, and an absorber for the refilling apparatus of cartridge and a refilling can for the refilling apparatus of cartridge, which can easily refill and replenish the ink cartridge with ink and adjust an air pressure within the ink cartridge.

### BACKGROUND ART

In general, an ink jet printer performs printing by jetting ink filled in an ink cartridge onto a paper. A user has to often replace the expensive ink cartridge since a relatively smaller amount of ink is filled in the ink cartridge, thereby causing inconvenience of refilling the ink cartridge with ink. Therefore, the ink jet printer can perform reprinting by separating the ink cartridge in which the ink is used up from the ink jet printer, refilling the ink cartridge with ink and then attaching the ink cartridge to the ink jet printer.

In the conventional method, the ink is refilled in the ink cartridge by using a syringe.

The ink refilling method using the syringe injects ink through an inlet of the ink cartridge, whereby it is difficult in cleaning a print head of the ink cartridge with minute holes. If the print head is not clean, the ink jet printer having the refilled ink cartridge attached thereon cannot conduct printing in an exact and clean manner. That is to say, the refilling method using the syringe causes a deposit of ink left in the ink cartridge after the ink is used up to be stuck to the print head, such that newly injected ink to the ink cartridge is not uniformly jetted onto the paper, and thus a clearly and cleanly printed paper cannot be output from the printer.

Further, the refilling method using the syringe has another disadvantage that after the ink is refilled, the injected ink leaks out from the inlet since the ink is refilled through the inlet of the ink cartridge. Thus, to prevent the ink from leaking out through the inlet of the ink cartridge, a solution absorber, such as an eyedropper, is used to extract an air inside the ink cartridge and thereby adjust an air pressure inside the ink cartridge. However, the eyedropper is not perfectly coupled with the ink cartridge, such that the air pressure inside the ink cartridge cannot be appropriately adjusted and therefore the refilled ink cartridge cannot be refreshed.

In consequence, the ink refilling method for the ink cartridge using the syringe according to the conventional art is problematic in that the ink cannot be refilled in the ink cartridge in a clean way and the ink leaking through the inlet of the ink cartridge should be removed by using the eyedropper. In addition, a defective proportion in refreshment of the refilled ink cartridge is increased since the eyedropper cannot appropriately adjust the air pressure inside the ink cartridge. The refilling method in the conventional art has still another disadvantages that the refilling process is difficult to do, a low success rate is achieved, and the refilled ink cartridge cannot output printed materials cleanly.

### DISCLOSURE OF INVENTION

Accordingly, the present invention is directed to a refilling apparatus for an ink cartridge, and an absorber and a refilling can for the same that substantially obviate one or more problems due to limitations and disadvantages of the related art.

An object of the present invention is to provide a refilling apparatus for an ink cartridge, which can refill and/or replenish the ink cartridge with ink.

Another object of the present invention is to provide a refilling apparatus for an ink cartridge, an absorber and a refilling can for the same, which can easily refill and/or replenish the ink cartridge with ink, adjust an air pressure inside the refilled and/or replenished ink cartridge, and equalize a pressure.

Further another object of the present invention is to provide a refilling apparatus for an ink cartridge, and an absorber for the same for adsorbing air and/or ink from the ink cartridge, which can easily refill and/or replenish the ink cartridge with ink, and thereafter equalize an air pressure so as for the ink not to leak from the refilled and/or replenished ink cartridge.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a refilling apparatus for an ink cartridge, which refills and/or replenishes the ink cartridge with ink, the refilling apparatus comprising: a refilling holder for filling the ink cartridge with ink by being coupled with a refilling ink container; and ink adsorbing means for adsorbing or sucking out air and/or ink to adjust an air pressure inside the ink cartridge.

An absorber for the refilling apparatus of the ink cartridge, the absorber which adjusts the air pressure inside ink cartridge after the ink cartridge is replenished with ink, includes a cylinder having an ink sucking hole arranged near to an ink inlet of the cartridge; a piston being inserted into the cylinder to slide in a predetermined range and being supported by an elastic force of a return spring, for generating an ink sucking force from the ink sucking hole when the return spring is expanded and restored; stopper means for stopping a restoration operation due to a force of the return spring in the piston when the piston is compressed in a predetermined amount inside the cylinder; and a push button being disposed on the cylinder side to release the stopper means.

A refilling can for the refilling apparatus of the ink cartridge allows the ink contained inside to be jetted by the air pressure.

It is to be understood that both the foregoing general description and the following detailed description of the present invention are exemplary and explanatory and are intended to provide further explanation of the invention as claimed.

### BRIEF DESCRIPTION OF THE DRAWINGS

Further objects and advantages of the invention can be more fully understood from the following detailed description taken in conjunction with the accompanying drawings in which:

FIG. 1 is a perspective view of a refilling holder applied to a preferred embodiment of the present invention;

FIG. 2 is an exploded perspective view of an absorber and a refilling apparatus according to the preferred embodiment of the present invention;

FIG. 3 is a view illustrating a state that a refilling can installed on the refilling apparatus is used according to the preferred embodiment of the present invention;

FIG. 4 is a view illustrating a state the absorber applied to the preferred embodiment of the present invention is assembled;

FIG. 5 is a view illustrating a state that the absorber applied to the preferred embodiment of the present invention is operated;

FIG. 6 is a view of a refilling holder applied to another preferred embodiment of the present invention;

FIG. 7A and FIG. 7B are views illustrating a state that a connection nozzle applied to the present invention and ink inlet opening means of the another preferred embodiment are used; and

FIG. 8 is a view illustrating a construction for explaining a method of separating refilled ink from the refilling apparatus according to the present invention.

### BEST MODE FOR CARRYING OUT THE INVENTION

The present invention will now be described in detail in connection with preferred embodiments with reference to the accompanying drawings. For reference, like reference characters designate corresponding parts throughout several views.

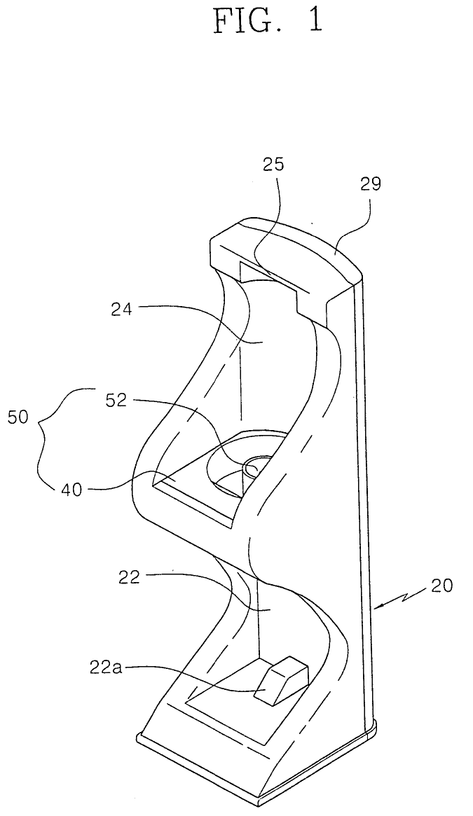

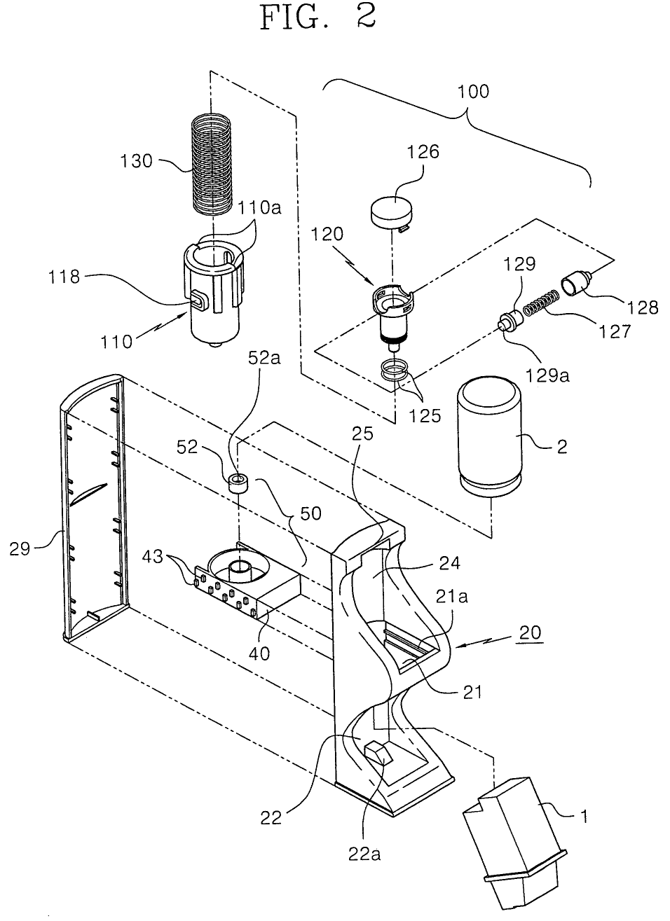

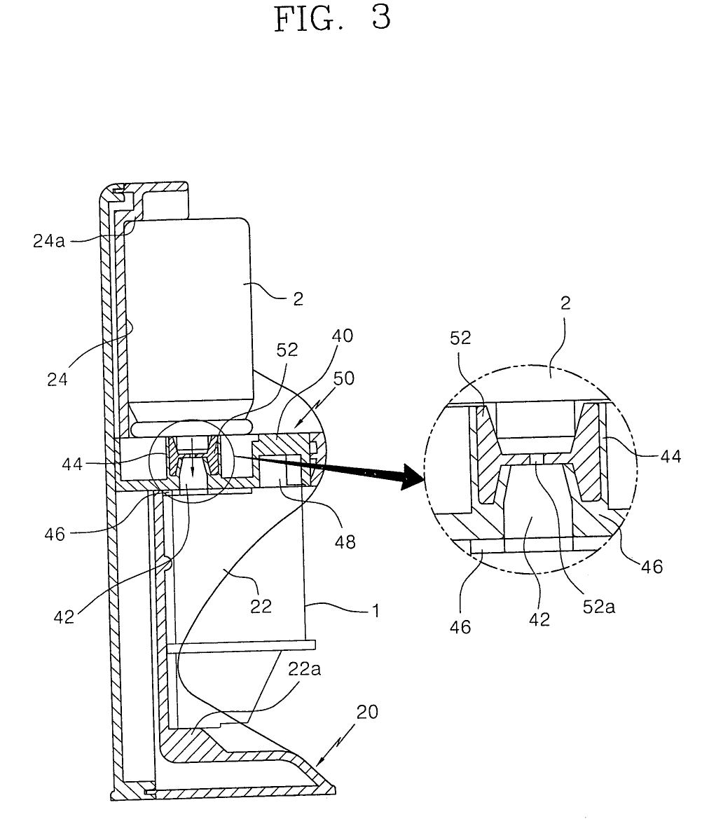

FIG. 1 is a perspective view of a refilling holder applied to a preferred embodiment of the present invention. FIG. 2 is an exploded perspective view of a refilling apparatus and an absorber for the same according to the preferred embodiment of the present invention. FIG. 3 is a view illustrating a state that a refilling can mounted on the refilling apparatus is used according to the preferred embodiment of the present invention. The refilling holder 20 is provided with an ink cartridge receiving unit 22 for receiving an ink cartridge to be removably formed on a lower part thereof, and an ink refilling can receiving unit 24 for receiving an ink refilling can 2 or an absorber 100 for the ink cartridge, which is to be explained later, to be selectively mounted on and detached from an upper part of the ink cartridge.

The ink cartridge receiving unit 22 is provided with a support jaw 22a protruding on a lower surface thereof. The support jaw 22a supports a lower surface of the ink cartridge 1 when the ink cartridge 1 is pushed into the ink cartridge receiving unit 22.

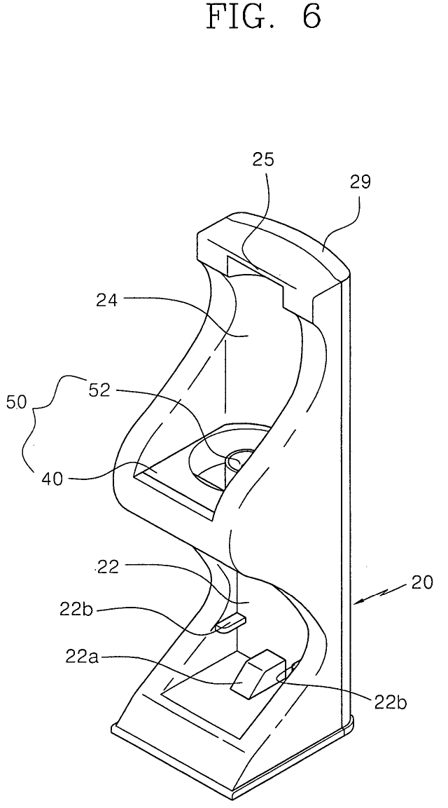

Meantime, as illustrated in FIG. 6, the ink cartridge receiving unit 22 may further have projections 22b and 22b on inside surfaces facing each other to prevent a lateral motion of the ink cartridge 1.

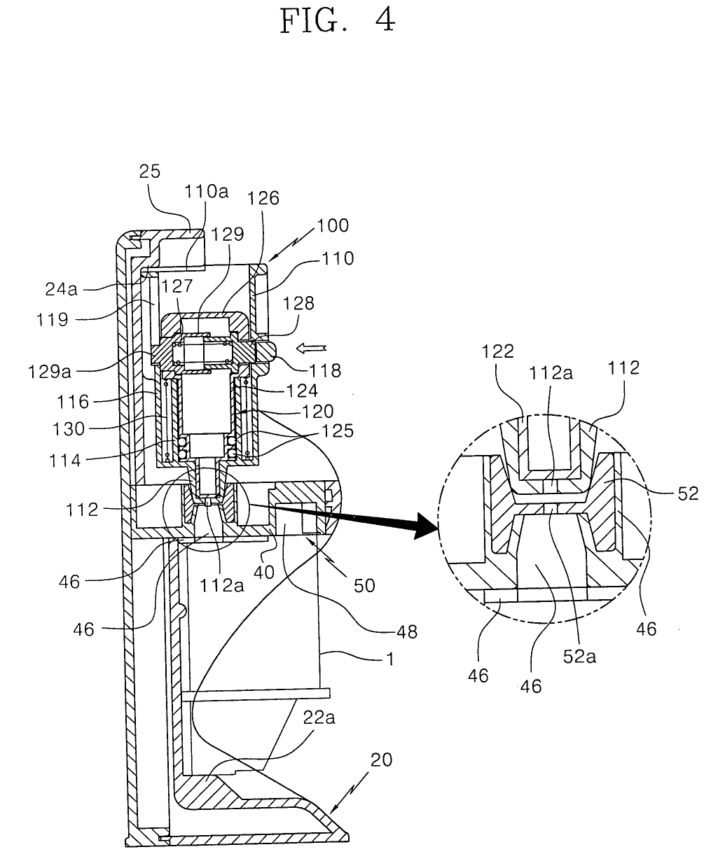

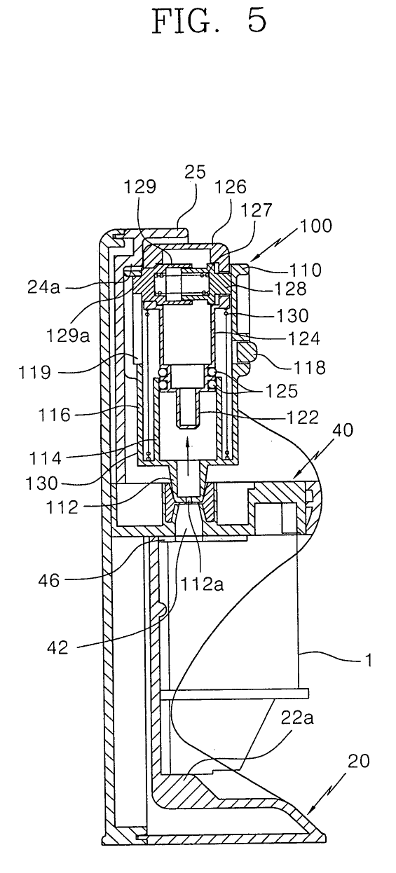

A shown in FIG. 4 and FIG. 5, a projection 24a on which the absorber 100 for the ink cartridge or the ink refilling can 2 is fitted is provided on an upper unit of the ink refilling can receiving unit 24, and a safety jaw 25 is provided on an upper part of the projection 24a so as for a piston of the absorber 100 for the ink cartridge not to be separated during operation.

In the meanwhile, ink inlet opening means 50 interposed between the ink cartridge receiving unit 22 and the ink refilling can receiving unit 24 is installed on the refilling holder 20.

The ink inlet opening means exposes an inlet of the ink cartridge received in the refilling holder 20 and at the same time provides an inlet path of refilled ink.

The ink inlet opening means, as shown in FIGS. 3, 4, 7A and 7B, is interposed between the ink refilling can receiving unit 24 and the ink cartridge receiving unit 22, and includes a packing 52 having an ink inlet hole 52a.

The packing 52 is assembled on a packing bracket 40 which is attachable on and detachable from the refilling holder 20 in the preferred embodiment. The packing bracket 40 is assembled to be attached on and detached from a rear side of a bracket insertion hole 21 that is formed between the ink cartridge receiving unit 22 and the ink refilling can receiving unit 24. Guide rails 21a are formed on both the side walls of the bracket insertion hole 21.

The packing bracket 40 includes a bored ink path hole 42, a cylindrical packing mounting unit 44 for assembling the packing 52 in the ink path hole 42, a pad 46 for closely contacting the circumference of the inlet of the ink cartridge by being attached on a lower surface of the ink path hole 42, and a fixing hole 48 for fixing an upper side of the ink cartridge 1 on a side of the pad 46.

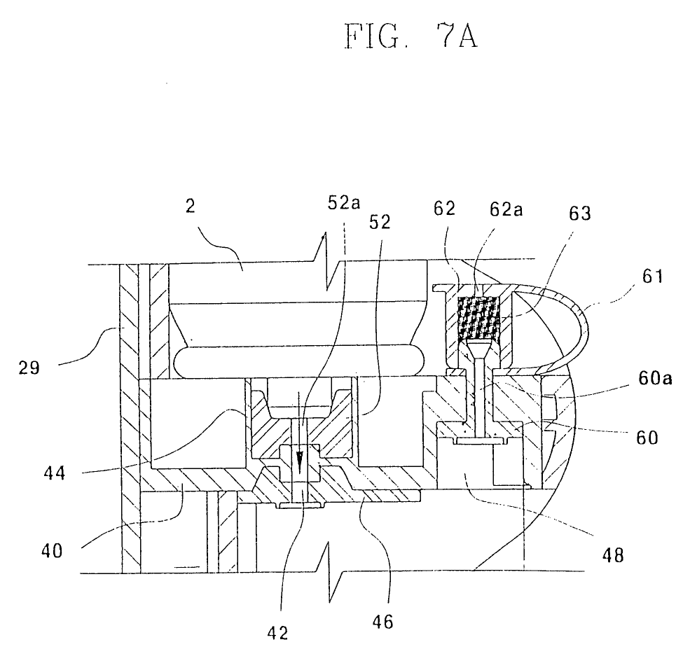

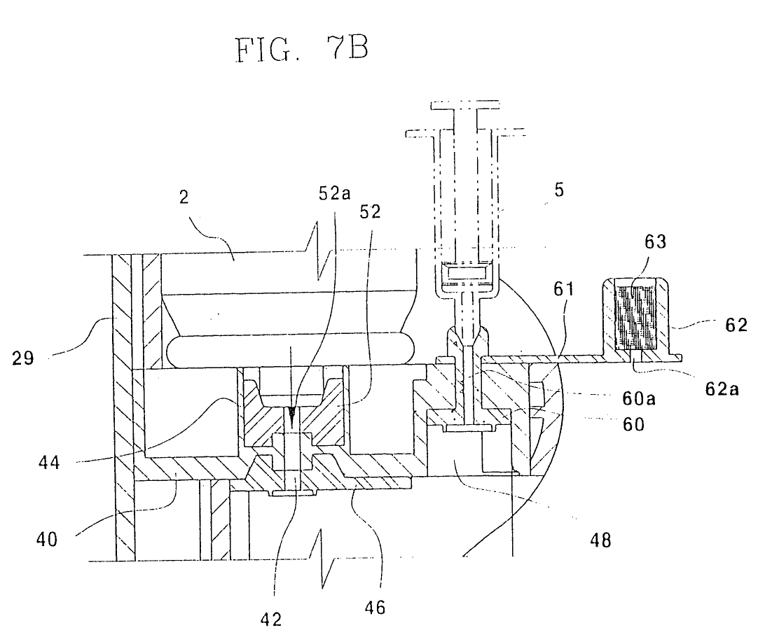

On the other hand, the ink inlet opening means drawn in FIG. 3 and FIG. 4 may be changed into one according to another preferred embodiment of the present invention as shown in FIG. 7A and FIG. 7B.

The packing bracket 40 constructed as above may be inserted into or detached from the bracket insertion hole 21 on a rear surface side of the refilling holder 20. At this time, a plurality of rail support jaws 43 are provided on both side surfaces of the packet bracket 40 to be slidably fitted into the guide rails 21a.

The refilling holder 20 allows a refilling cover 29 to be removably mounted on a rear surface thereof. The refilling cover 29 serves to protect the packing bracket 40 inserted into the refilling holder 20 from being separated.

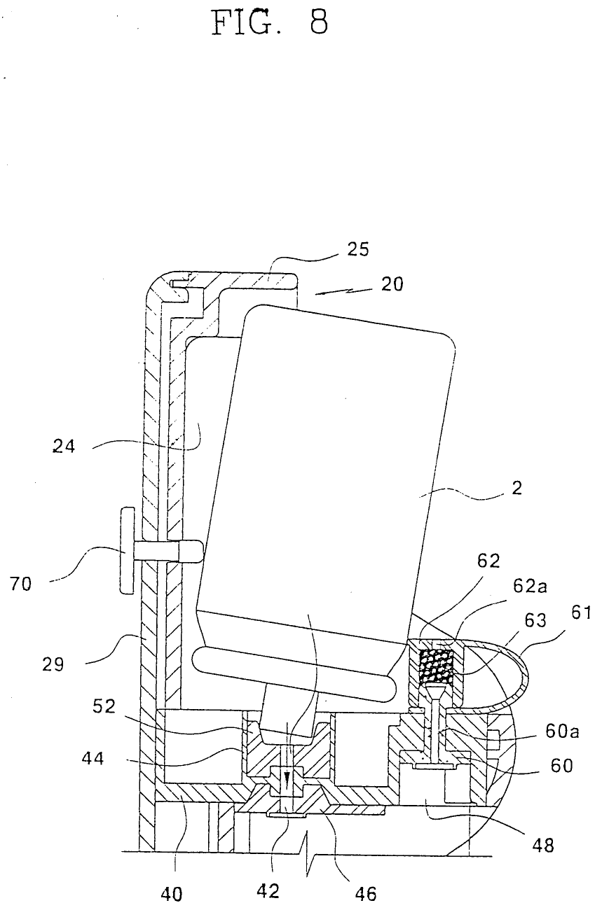

FIG. 8 is a view illustrating a construction for explaining a method for separating the refilled ink from the refilling apparatus. The refilling holder 20 has a push button 70 on a rear surface thereof to instantly detach the ink refilling can 2 if necessary during ink injection.

The push button 70 is forcibly inserted into the refilling cover 29 on a front end part thereof so as not be separated by a projection 71, and installed to be somewhat freely moved. Thus, when the ink refilling can 2 is mounted on the ink refilling can receiving unit 24, the push button is in a backward position. At this state, when the push button 70 is pressed, the refilling can 2 is easily inclined to an open side so as to be separated.

As shown in FIGS. 7A and 7B, the refilling apparatus according to the present invention may further install a connection nozzle 60 on the ink cartridge 1 to remove overfilled ink.

FIG. 7A shows a state where a rubber cap 62 is closed in the connection nozzle 60. FIG. 7B shows a state where the rubber cap 62 is opened and a general syringe 5 is put on the connection nozzle 60 to extract the overfilled ink.

The connection nozzle 60 is materialized of rubber and fixedly inserted into the packing bracket 40. A suction path 60a is vertically formed at the center of the connection nozzle 60. The rubber cap 62 is connected by means of a connection unit 61 which is forcibly inserted into the connection nozzle 60. An absorber 63 is embedded within the rubber cap 62 to absorb ink which is overfilled and flows out. A perforated pressure relief hole 62a is formed on an upper surface of the rubber cap 62 to remove a pressure.

Therefore, if ink is overfilled in the ink cartridge 1 when the rubber cap 62 is inserted into the connection nozzle 60, the pressure is removed in the pressure relief hole 62a and a part of the leaked ink is absorbed by the absorber 63 of the rubber cap 62. Upon this condition, an air pressure inside the ink cartridge is adjusted, as shown in FIG. 7B, by opening the rubber cap 62, and sucking out more ink and/or air so that the inner air pressure can be equalized through the inlet of the cartridge by using the syringe 5 and accordingly the ink can be protected from leaking out any further.

In addition, a head or a filter is kept clean by sucking remnants inside the ink cartridge by using the syringe.

A method for refilling the ink cartridge with ink by using the refilling holder 20 constructed as above will be explained herein after.

First, as drawn in FIG. 3, the ink cartridge 1 is mounted in the ink cartridge receiving unit 22 of the refilling holder 20. In a state that the upper part of the ink cartridge is inserted into and fixed on the fixing hole 48 of the packing bracket 40, the lower part of the ink cartridge 1 is pushed toward the support jaw 22a. Accordingly, the inlet of the ink cartridge is closely contacted with the pad 46 on the packing bracket 40 side, and coincided with the ink inlet hole 52a of the packing 52. In this situation, the ink refilling can 2 is inserted into the ink refilling can receiving unit 24 on the upper part of the refilling holder 20.

Thereafter, while the inlet of the ink refilling can 2 is put on the packing 52 and the upper part of the ink refilling can 2 is positioned on a lower surface of the projection 24a, the ink refilling can is mounted. Then, the inlet of the ink refilling can 2 is closely contacted with an inner peripheral surface of the packing while being connected to the ink inlet hole 52a of the packing 52, and simultaneously the inlet of the ink refilling can 2 is opened.

As a result, the ink is automatically discharged by the inner pressure of the ink refilling can 2 and introduced to the inside of the ink cartridge through the ink inlet hole 52a. Through that course, an injection time is finished in several minutes and an initial refilling is simply and easily completed.

However, after the initial refilling is completed, if the ink refilling can 2 is removed from the refilling holder 20, and the ink cartridge 1 is detached and then is inclined, the inlet of the ink cartridge 1 is in an open state after the refilling due to its structure and the ink flows out through the inlet due to the inner air pressure.

Accordingly, to close the inlet of the ink cartridge after the initial refilling and prevent the ink from leaking out, as illustrated in FIG. 2 and FIG. 4, the absorber 100 for the ink cartridge is employed on the refilling holder according to the present invention.

FIG. 4 is a view illustrating a state that the absorber applied to the preferred embodiment of the present invention is assembled. FIG. 5 is a view illustrating a state that the absorber applied to the preferred embodiment of the present invention is operated. The absorber 100 is installed on the refilling holder 20 according to the present invention.

The absorber 100 includes a cylinder 110, a piston 120 and a return spring 130.

The cylinder 110 includes a small cylinder unit 112 of a small diameter having a suction hole 112a whose center is passed through, an inner cylinder unit 114 of an intermediate diameter extending from the small cylinder unit 112, and a large outer cylinder unit 116 of a large diameter extending from the small cylinder unit 112 and surrounding the inner cylinder unit 114 with a predetermined interval from the inner cylinder unit 114. The outer cylinder unit 116 is provided with a push button 118 and a cylinder guide long hole 119. A stepped jaw 110a forming a different step over a semicircle for determining an insertion direction of the cylinder 110 by being inserted into the assembled refilling holder 20 is formed on the uppermost surface of the cylinder 110 so as for a user to operate the push button 118.

While vertically sliding inside the cylinder 110, the piston 120 generates a vacuum force in the suction hole 112 when adsorbing the ink of the ink cartridge. For this, the piston includes an intermediate shaft unit 124 having a diameter approximately similar to that of the inner cylinder unit 114 of the cylinder 110, a small shaft unit 122 extending at the center of a lower end of the intermediate shaft unit 124 and having a diameter smaller than that of the small cylinder unit 112, a piston cap 126 being mounted on the intermediate shaft unit 124, and a stopper 128 being installed inside the piston cap 126 and supported by an elastic force of a spring 127.

Here, a plurality of O-rings 125 are interposed in the intermediate unit 124, whereby a suction force is generated in the suction hole 112a of the cylinder 110 when the piston 120 is backwardly operated.

The spring 127 compressed in a stopper housing 129 is formed between the stopper 128 and the stopper housing 129. The stopper housing 129 upwardly and downwardly slides in the cylinder guide long hole 119, and is provided with a protrusion jaw 129a for limiting an upward movement of the piston 120.

The return spring 130 is compressed between the cylinder 110 and the piston 120 to suddenly raise the piston 120.

A state that the absorber 100 constructed as above is assembled and operated will be explained herein below.

First, the return spring 130 is inserted between the inner cylinder unit 114 of the cylinder 110 and the outer cylinder unit 116. The piston 120 is inserted into an inner diameter part of the cylinder 110. Here, the protrusion jaw 129a on the stopper housing 129 side is inserted into the cylinder guide long hole 119 of the cylinder 110, such that the stopper 128 is fitted to the push button 118. As a consequence, the return spring 130 is compressed and the piston 120 receives an elastic repulsive force of the return spring 130.

In this state, if the push button 118 is pressed, the stopper 128 is released from the fitted condition on the push button 118, the cylinder 120 is instantly moved up by the elastic repulsive force of the return spring 130, and a suction force is generated in the suction hole 112a on the cylinder 120 side due to the upward movement.

Therefore, once the initial refilling is completed in the ink cartridge 1, the ink refilling can 2 is detached and the absorber 100 is mounted on the ink refilling can receiving unit 24 of the refilling holder 20 in a state that the ink cartridge 1 is mounted on the refilling holder 20 as it is.

As a result, a lower end circumference of the small cylinder unit 112 on which the suction hole 112a formed on the lower end side of the absorber 100 is positioned is closely contacted with an inner peripheral surface of the packing 52, as shown in FIG. 4. Here, the absorber 100 is inserted, avoiding the stepped jaw 110a. In the piston 120, the stopper 128 is fitted to the push button 118 while the return spring 130 is compressed.

At this point, if the push button 118 is pressed, the stopper 128 is released from the push button 118, and instantly raised by an inertia-based restoration force of the return spring 130, as illustrated in FIG. 5.

Hence, the suction force is generated inside the cylinder 120, sucks air and/or ink inside the ink cartridge through the suction hole 112a to equalize the air pressure inside the ink cartridge, and adsorbs a ball inside the ink cartridge to close the inlet, leading to prevention of further ink leakage from the ink cartridge.

The absorber 100 used as above is applicable by coupling the suction hole 112a thereof to the inlet of the ink cartridge 1 as well as being applicable by being mounted on the refilling holder 20.

### INDUSTRIAL APPLICABILITY

As described above, the refilling apparatus of the ink cartridge, and the absorber and the refilling can for the same according to the present invention can refill the ink cartridge with ink in an easy and clean manner. Additionally, an ink jet printer on which the ink cartridge is installed can ensure a clear printing by properly adjusting the air pressure inside the ink cartridge. Further, a printer on which the refilled ink cartridge is installed can conduct printing under a clean condition, since the ink is prevented from leaking out further from the inlet of the ink cartridge during the refilling process.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A refilling apparatus for an ink cartridge, which refills and/or replenishes the ink cartridge with ink, the refilling apparatus comprising:
a refilling holder being coupled with a refilling ink can to fill or replenish the ink cartridge with ink; and
ink absorbing means for adsorbing air and/or ink to generate an equalized pressure and protect any ink from leaking out from the ink cartridge by adjusting an air pressure inside the ink cartridge.

2. The refilling apparatus of claim 1, wherein the refilling holder comprising:
an ink refilling can receiving unit for receiving the ink refilling can;
an ink cartridge receiving unit being arranged adjacent to the ink refilling can receiving unit, for receiving the ink cartridge; and
ink inlet opening means being interposed between the ink refilling can receiving unit and the ink cartridge receiving unit, for opening an ink inlet of the ink refilling can when the ink refilling can is installed in the ink refilling can receiving unit.

3. The refilling apparatus of claim 2, wherein the refilling holder comprising:
a suction hole for sucking overfilled ink in the ink cartridge received in the ink cartridge receiving unit; and
a syringe connection nozzle being attached to the circumference of the suction hole.

4. The refilling apparatus of claim 3, wherein the syringe connection nozzle comprises an absorber for absorbing ink, and further includes a rubber cap for opening and closing the suction hole.

5. The refilling apparatus of claim 2, wherein the refilling holder further comprises a push button for detaching the ink refilling can from the ink refilling can receiving unit.

6. The refilling apparatus of claim 2, wherein the ink inlet opening means comprises:
a packing bracket being removably interposed between the ink refilling can receiving unit of the refilling holder and the ink cartridge receiving unit, and including an ink path hole;
an ink intake packing 52 being assembled on a packing bracket coaxially with the ink path hole, and being arranged on a straight line with the ink path hole; and
a contact pad being closely contacted with the circumference of an ink inlet of the ink cartridge received in the ink cartridge receiving unit by being attached to the packing bracket on a lower side of the ink path hole.

8. The refilling apparatus of claim 1, wherein the ink adsorbing means comprises:
a cylinder being attachable on and detachable from the ink refilling can receiving unit of the refilling holder, and having an ink suction hole in communication with the ink intake packing;
a piston being inserted into an inside of the cylinder to slide in a predetermined range and being supported by an elastic force of a return spring, for generating an ink suction force from the ink suction hole when the return spring is expanded and restored;
stopper means for stopping a restoration operation by a force of the return spring of the piston when the piston is compressed to a predetermined amount within the cylinder; and
a push button being provided on the cylinder side to release the stopper means.

9. The refilling apparatus of claim 8, wherein a projection is formed on an upper part of the ink refilling can receiving unit to make an upper end of the cylinder or the ink refilling can possible to be fitted thereto.

10. The refilling apparatus of claim 2, wherein a projection is formed on an upper part of the ink refilling can receiving unit to make an upper end of the cylinder or the ink refilling can possible to be fitted thereto.

11. The refilling apparatus of claim 2, wherein ink contained inside the refilling can is jetted by the air pressure.

12. The refilling apparatus of claim 2, further comprising an absorber for adjusting the air pressure inside the ink cartridge after the ink cartridge is replenished with ink.

13. The refilling apparatus of claim 12, wherein the absorber comprises:
a cylinder having an ink suction hole arranged adjacent to the ink inlet of the ink cartridge;
a piston being inserted into an inside of the cylinder to slide in a predetermined range and being supported by an elastic force of a return spring, for generating an ink suction force from the ink suction hole when the return spring is expanded and restored;
stopper means for stopping a restoration operation by a force of the return spring of the piston when the piston is compressed to a predetermined amount within the cylinder; and
a push button being provided on the cylinder side to release the stopper means.

14. An absorber for adjusting an air pressure inside an ink cartridge after the ink cartridge is replenished with ink, the absorber comprising:
a cylinder having an ink suction hole arranged adjacent to an ink inlet of the cartridge;
a piston being inserted into an inside of the cylinder to slide in a predetermined range and being supported by an elastic force of a return spring, for generating an ink suction force from the ink suction hole when the return spring is expanded and restored;
stopper means for stopping a restoration operation by a force of the return spring of the piston when the piston is compressed to a predetermined amount within the cylinder; and
a push button being provided on the cylinder side to release the stopper means.

15. The absorber of claim 14, wherein the stopper means comprises:
a stopper and a stopper housing being arranged to horizontally face each other on an upper part of the piston, and being assembled to slide; and
a spring being installed between the stopper and the stopper housing to be compressed to a predetermined extent,
wherein an outside end part of the stopper is fitted to the cylinder side toward the push button when the stopper reaches the position of the push button.

16. A refilling can for a refilling apparatus of an ink cartridge, characterized in that ink contained inside the refilling can is jetted by an air pressure.
